(19) United States
(12) Patent Application Publication
(10) Pub. No.: US 2024/0377185 A1
(43) Pub. Date: Nov. 14, 2024

(54) System and Method for Dimensioning Objects

(71) Applicant: ZEBRA TECHNOLOGIES CORPORATION, Lincolnshire, IL (US)

(72) Inventors: Raghavendra Tenkasi Shankar, Holbrook, NY (US); Joseph D. Moreira, Barrington, RI (US)

(21) Appl. No.: 18/196,052

(22) Filed: May 11, 2023

(51) Int. Cl. G01B 11/02; G06T 7/62; G06V 20/64

(52) U.S. Cl. CPC G01B 11/022; G06T 7/62; G06V 20/64; G01S 17/86

(57) ABSTRACT

A method for dimensioning a target object includes: obtaining preliminary dimensioning data representing the target object; determining, based on the preliminary dimensioning data, a shape classification for the target object; when the shape classification for the target object is cuboidal, applying a cuboidal dimensioning function to the preliminary dimensioning data to obtain object dimensions; when the shape classification for the target object is non-cuboidal: selecting a non-cuboidal dimensioning function based on a preliminary bounding box of the target object detected in the preliminary dimensioning data; applying the non-cuboidal dimensioning function to obtain the object dimensions.

### BACKGROUND

Determining the dimensions of objects may be necessary in a wide variety of applications. For example, it may be desirable to determine the dimensions of freight, parcels, packages in a warehouse prior to shipping or storage. Different shapes and sizes of objects may be optimally dimensioned by different dimensioning functions. It may be difficult for a human operator to make a judgement of the object fitting into one category or another to select an appropriate dimensioning function.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for selecting a dimensioning function and dimensioning objects

FIG. 2 is a block diagram of certain internal hardware components of the detection device of FIG. 1.

FIG. 3 is a flowchart of a method of selecting a dimensioning function and dimensioning objects.

FIG. 4 is a flowchart of an example method of applying a non-cuboidal dimensioning function at block 325 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method comprising: obtaining preliminary dimensioning data representing the target object; determining, based on the preliminary dimensioning data, a shape classification for the target object; when the shape classification for the target object is cuboidal, applying a cuboidal dimensioning function to the preliminary dimensioning data to obtain object dimensions; when the shape classification for the target object is non-cuboidal: selecting a non-cuboidal dimensioning function based on the preliminary dimensioning data; applying the non-cuboidal dimensioning function to obtain the object dimensions.

Additional examples disclosed herein are directed to a device comprising: a memory storing a cuboidal dimensioning function and one or more non-cuboidal dimensioning functions; a processor interconnected with the memory, the processor configured to: obtain preliminary dimensioning data representing a target object to be dimensioned; determine, based on the preliminary dimensioning data, a shape classification for the target object; when the shape classification for the target object is cuboidal, apply the cuboidal dimensioning function to the preliminary dimensioning data to obtain object dimensions; when the shape classification for the target object is non-cuboidal: select a non-cuboidal dimensioning function based on the preliminary dimensioning data; apply the selected non-cuboidal dimensioning function to obtain the object dimensions.

Additional examples disclosed herein are directed to a method comprising: A method for dimensioning a target object, the method comprising: obtaining preliminary dimensioning data representing the target object; segmenting the preliminary dimensioning data; detecting, in the segmented preliminary dimensioning data, a top plane of the target object to identify the target object as cuboidal; in response to detecting the top plane, applying a cuboidal dimensioning function to the preliminary dimensioning data to obtain object dimensions.

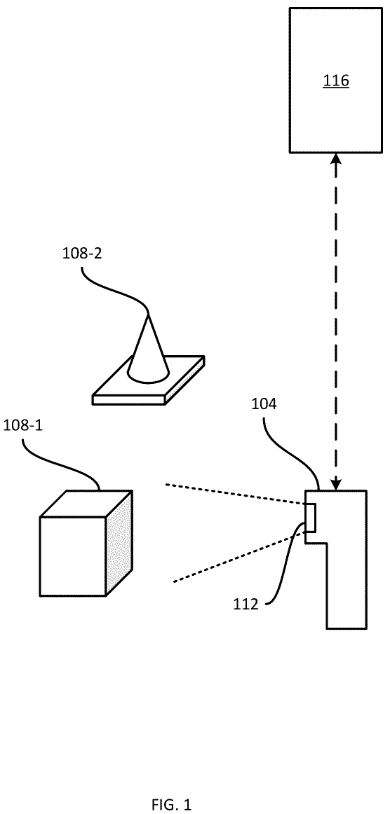

FIG. 1 depicts a system 100 for selecting a dimensioning function and dimensioning objects in accordance with the teachings of this disclosure. The system 100 includes a computing device 104 (also referred to herein as the dimensioning device 104 or simply the device 104) configured to dimension one or more target objects 108-1 and 108-2 (referred to herein generically as an object 108, and collectively as the objects 108; this nomenclature is used elsewhere herein) according to a selected dimensioning function. For example, the objects 108 may be items, such as boxes or other packages, in a transport and logistics facility. As can be seen, the object 108-1 is a regular, cuboidal box defined by a length/depth, width, and height, while the object 108-2 has a non-uniform structure.

The device 104 may be a mobile computing device, such as a mobile phone, a tablet, a barcode scanner, a dedicated dimensioning device, or the like. In such examples, the device 104 may include an integrated sensor, or set of sensors 112, such as image sensors (e.g., optical cameras, infrared sensors, etc.), depth sensors (e.g., LIDAR, etc.), ambient light sensors, proximity sensors, temperature sensors, and the like to capture dimensioning data representing the objects 108. In particular, the specific set of sensors 112 may be selected based on the specific dimensioning functions to be executed in a dimensioning operation by the device 104. In other examples, the device 104 may be a fixed computing device such as a desktop computer, a kiosk, or the like, and the device 104 may be associated with the set of sensors 112 to obtain data from the sensors 112 to dimension the objects 108.

The device 104 may be in communication with a server 116 via a communication link, illustrated in the present example as including wireless links. For example, the link may be provided by a wireless local area network (WLAN) deployed by one or more access points (not shown). In other examples, the server 116 is located remotely from the device 104 and the link may therefore include one or more wide-area networks such as the Internet, mobile networks, and the like. The server 116 may be any suitable server environment, including a plurality of cooperating servers operating, for example in a cloud-based environment.

The system 100 is generally deployed to dimension target objects, such as the objects 108. In particular, the dimensioning device 104 is configured to obtain preliminary dimensioning data representing the target object to be dimensioned. Using the preliminary dimensioning data, the device 104 may first determine a shape classification for the target object, as cuboidal or non-cuboidal. Based on the shape classification, the device 104 may apply a cuboidal dimensioning function, or select an appropriate non-cuboidal dimensioning function, as will be described further herein.

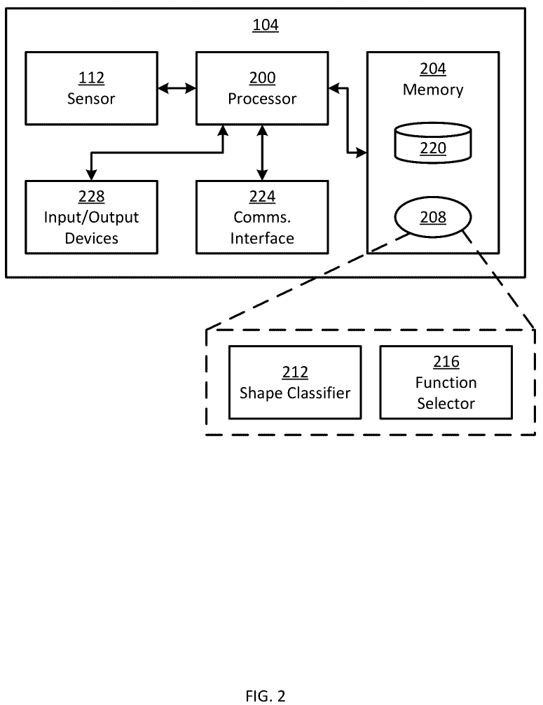

Turning now to FIG. 2, certain internal components of the dimensioning device 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits.

The memory 204 stores computer-readable instructions for execution by the processor 200. In particular, the memory 204 stores an application 208 which, when executed by the processor, configures the processor 200 to perform various functions discussed below in greater detail and related to the dimensioning operation of the device 104.

In particular, the application 208 includes a shape classifier 212 and a function selector 216. The shape classifier 212 is generally configured to analyze preliminary dimensioning data representing a target object and determine a shape classification for the target object. In particular, the shape classifier 212 may output a shape classification of either ‘cuboidal’ or ‘non-cuboidal’. The function selector 216 is generally configured to analyze preliminary data representing a target object and determine a suitable dimensioning function to be applied to dimension the target object. In particular, the function selector 216 may select a dimensioning function from a plurality of predefined dimensioning functions. The function selector 216 may further be particularly applied to select a dimensioning function for an irregular or non-cuboidal object.

Some or all of the application 208 may also be implemented as a suite of distinct applications. For example, the shape classifier 212 and the function selector 216 may be implemented as distinct applications rather than as modules of the application 208. Further, in some examples, each of the dimensioning functions, including a cuboidal dimensioning function, and one or more non-cuboidal dimensioning functions.

Those skilled in the art will appreciate that the functionality implemented by the processor 200 may also be implemented by one or more specially designed hardware and firmware components, such as a field-programmable gate array (FPGAs), application-specific integrated circuits (ASICs) and the like in other embodiments. In an embodiment, the processor 200 may be, respectively, a special purpose processor which may be implemented via dedicated logic circuitry of an ASIC, an FPGA, or the like in order to enhance the processing speed of the operations discussed herein.

The memory 204 also stores a repository 220 storing rules and data for the dimensioning operation. For example, the repository 220 may store an annotated dataset containing data (e.g., image data, depth data, etc.) representing target objects and annotations for the data. In particular the annotations may define various classifications of the target objects represented by the data, such as a shape classification of the target object, a classification of a non-cuboidal dimensioning function used to dimension the target object, a bounding box for the target object, and the like.

In some examples, the shape classifier 212 may include a machine learning-based shape classification model trained on a subset of the annotated dataset in the repository 220. That is, the shape classification model may be trained on data representing a given target object and annotated with a shape classification of either ‘cuboidal’ or ‘non-cuboidal’ for the given target object. Accordingly, the shape classifier 212 may accept preliminary dimensioning data as an input and apply the shape classification model to obtain a shape classification of ‘cuboidal’ or ‘non-cuboidal’ for a target object represented by the preliminary dimensioning data.

Similarly, in some examples, the function classifier 216 may include a machine learning-based function classification model trained on a subset of the annotated dataset in the repository 220. That is, the function classification model may be trained on data representing a given irregular or non-cuboidal target object and annotated with a type of function, and particularly a function for dimensioning irregular objects, used to dimension the given irregular target object. In some examples, the data may further be annotated with a bounding box used to dimension the given target object to train the model to select an appropriate dimensioning function for the given target object contained in the bounding box.

The device 104 also includes a communications interface 224 enabling the device 104 to exchange data with other computing devices such as the server 116. The communications interface 224 is interconnected with the processor 200 and includes suitable hardware (e.g., transmitters, receivers, network interface controllers and the like) allowing the device 104 to communicate with other computing devices—such as the server 116. The specific components of the communications interface 224 are selected based on the type of network or other links that the device 104 is to communicate over.

The device 104 may further include one or more input and/or output devices 228. The input devices may include one or more buttons, keypads, touch-sensitive display screens or the like for receiving input from an operator. The output devices may further include one or more display screens, sound generators, vibrators, or the like for providing output or feedback to an operator.

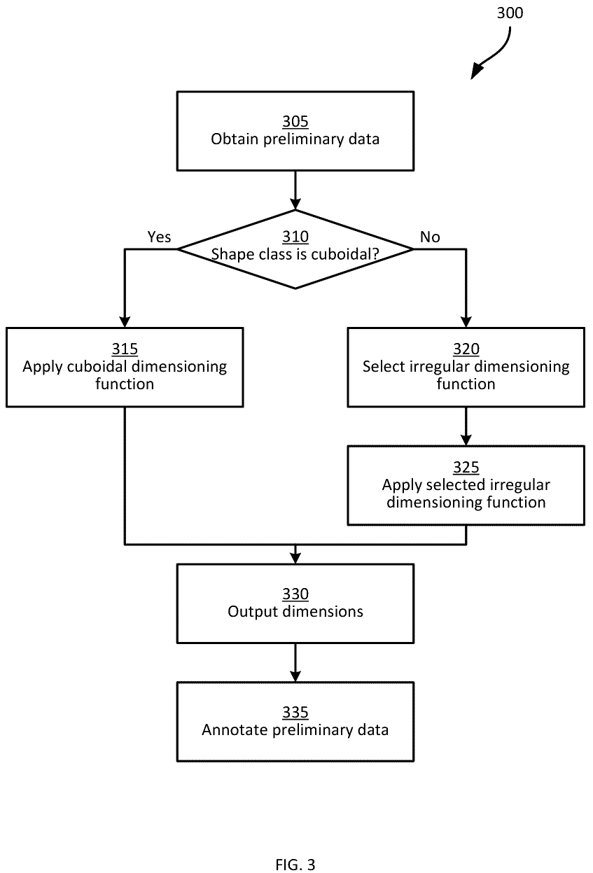

Turning now to FIG. 3, the functionality implemented by the device 104 will be discussed in greater detail. FIG. 3 illustrates a method 300 of dimensioning a target object. The method 300 will be discussed in conjunction with its performance in the system 100, and particularly by the device 104, via execution of the application 208. In particular, the method 300 will be described with reference to the components of FIGS. 1 and 2. In other examples, some or all of the method 300 may be performed by other suitable devices or systems, such as the server 116.

The method 300 is initiated at block 305, where the device 104 obtains preliminary dimensioning data representing one of the target objects 108. For example, the device 104 may control the sensors 112 to capture the preliminary dimensioning data representing the target object. The preliminary dimensioning data may be image data (e.g., optical image data, infrared data or the like), depth data, combinations of the above, and the like. In some examples, the preliminary dimensioning data may further include other data (e.g., environmental data) detected by the sensors 112 during the dimensioning operation. In particular, the preliminary dimensioning data may preferably contain sufficient data for the device 104 to dimension a cuboidal target object using the preliminary dimensioning data.

In some examples, at block 305, prior to obtaining the preliminary dimensioning data, the device 104 may output, at the output device 228, instructions for obtaining the preliminary dimensioning data. For example, the device 104 may display text instructions and/or visual guidelines or produce an audio signal to prompt the operator to orient the sensors 112 of the device 104 towards the target object and to provide an input to initiate data capture by the sensors 112.

At block 310, the device 104 is configured to analyze the preliminary dimensioning data obtained at block 305 to determine if the target object if a shape classification for the target object is cuboidal.

That is, the device 104 may first apply the object shape classifier 212 to the target object to obtain a shape classification for the target object. For example, the target object 108-1 may have a shape classification of ‘cuboidal’, while the target object 108-2 may have a shape classification of ‘irregular’ or ‘non-cuboidal’.

For example, to determine the shape classification for the target object, the device 104 may be configured to apply top plane detection and/or segmentation to the preliminary dimensioning data. If a top plane is detected in the segmented, then the device 104 may determine that the shape classification of the target object is ‘cuboidal’, while if no top plane is detected, then the device 104 may determine that the shape classification of the target object is ‘non-cuboidal’.

In other examples, the device 104 may be configured to apply the shape classification model to the preliminary dimensioning data to obtain the shape classification of the target object. That is, the device 104 may input the preliminary dimensioning data obtained at block 305 to the shape classification model and receive a determined shape classification as an output.

In still further examples, the device 104 may perform both top plane detection and application of the shape classification model. For example, the device 104 may first apply top plane detection, and if a top plane is detected, input the preliminary data to the shape classification model to verify the shape classification of ‘cuboidal’.

In other examples, other manners of shape classification and combinations thereof are also contemplated.

If the determination at block 310 is that the target object has a cuboidal shape classification, then the device 104 proceeds to block 315 to apply a cuboidal dimensioning function to determine the dimensions of the target object. For example, the cuboidal dimensioning function may include detecting and adjusting a boundary of the segmented top plane, detecting a platform, detecting at least one edge of the segmented top plane, and determining a bounding box of the cuboidal object. The dimensions of the target object may be defined based on the bounding box (i.e., having the height, width and depth as defined by the bounding box. In other examples, other suitable cuboidal dimensioning functions may be applied to obtain the dimensions of the target object.

If the determination at block 310 is that the target object has a non-cuboidal shape classification, then the device 104 proceeds to block 320. At block 320, the device 104 selects a non-cuboidal dimensioning function (i.e., a dimensioning function for an irregular or non-cuboidal object) based on the preliminary dimensioning data. For example, the device 104 may store a list of possible dimensioning functions from which to select the dimensioning function at block 320. For example, dimensioning functions may include a two-point capture technique, in which dimensioning data is captured for the target object from two opposing views of the target object, and a stream capture technique, in which dimensioning data is captured for the target object from an arc and/or path across or around the target object.

The device 104 may select the non-cuboidal dimensioning function based on a preliminary bounding box of the target object detected in the preliminary dimensioning data. That is, the device 104 may select the non-cuboidal dimensioning function based on the relative size of the target object to the preliminary dimensioning data. For example, if the preliminary bounding box is within the limits of the preliminary dimensioning data and/or occupies less than a threshold percentage of the preliminary dimensioning data, then the device 104 may determine that the target object is fully contained within the preliminary dimensioning data and the device 104 may select the two-point capture technique. If the preliminary bounding box exceeds the threshold percentage of the preliminary dimensioning data and/or at least one dimension of the preliminary bounding box is equal to that of the preliminary dimensioning data, then the device 104 may determine that the target object is too large to be captured in full by the two-point capture technique. Accordingly, the device 104 may select the stream capture technique to continually capture dimensioning data for the target object in an arc and/or a path across or around the target object.

In some examples, each dimensioning function may have a set of parameters or criteria for the preliminary dimensioning data for the dimensioning function to produce a good result (e.g., within a threshold accuracy, or with a threshold percent confidence, or the like). For example, the parameters may include lighting conditions, color of the target object, or other environmental factors detected by the set of sensors 112 and contained in the preliminary dimensioning data. Accordingly, the device 104 may select the dimensioning function based on other parameters of the preliminary dimensioning data.

In other examples, the device 104 may be configured to apply the function selection model to the preliminary dimensioning data to obtain the selected dimensioning function to use. That is, the device 104 may input the preliminary dimensioning data obtained at block 305 to the function selection model and receive a selected dimensioning function as an output.

In some examples, rather than performing blocks 310 and 320 separately and sequentially, the device 104 may be configured to apply a single machine learning-based preliminary data classification model to the preliminary dimensioning data. The preliminary data classification model may be trained on the annotated dataset, including data annotated with both the shape classification and the non-cuboidal dimensioning function used. Accordingly, the preliminary data classification model may accept the preliminary dimensioning data as an input and output the cuboidal dimensioning function if the target object is cuboidal or a selected non-cuboidal dimensioning function if the target object is non-cuboidal.

After selecting a non-cuboidal dimensioning function at block 320, the device 104 proceeds to block 325. At block 325, the device 104 applies the selected non-cuboidal dimensioning function to determine the dimensions of the target object.

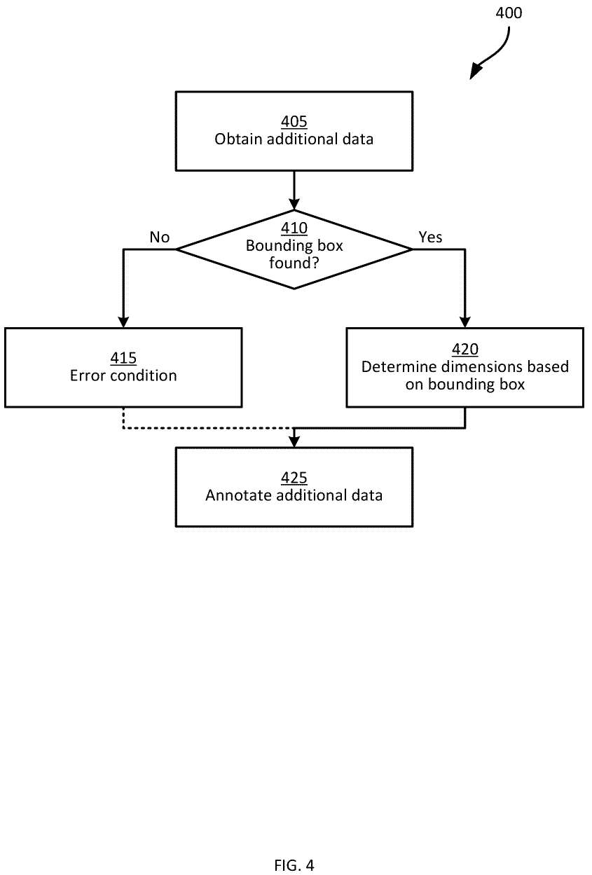

For example, referring to FIG. 4, a flowchart of an example method 400 of applying a non-cuboidal dimensioning function is depicted.

At block 405, the device 104 obtains additional dimensioning data representing the target object. For example, to obtain the additional dimensioning data, the device 104 may prompt the user to execute an additional interaction sequence of the device 104 with the target object. For example, the additional interaction sequence may be to capture a different view of the target object, for example from an opposing side of the target object. In other examples, the additional interaction sequence may be to scan or move the device 104 over the target object (e.g., in an arc or other predefined pattern). The additional interaction sequence may allow the device 104 to capture the additional dimensioning data to be used in the selected non-cuboidal dimensioning function. Accordingly, the additional interaction sequence may correspond to the selected non-cuboidal dimensioning function.

At block 410, the device 104 determines whether a bounding box for the object is detectable based on the additional dimensioning data captured at block 405.

In some examples, the device 104 may reconcile the preliminary dimensioning data with the additional dimensioning data to detect a bounding box. For example, the preliminary dimensioning data may represent a view of the target object from a first side while the additional dimensioning data may represent a view of the target object from the opposing side. Accordingly, the preliminary and additional dimensioning data may be correlated and reconciled to determine a single bounding box delimiting the irregularly shaped object.

In other examples, the bounding box for the object may be determined based solely on the additional dimensioning data. For example, when capturing sequential views of the target object as the device 104 is scanned across the target object in a predefined pattern, the device 104 may track the location of the object in the sequential views and correlate the views in the additional dimensioning data to detect a bounding box delimiting the irregularly shaped object.

If, at block 410, a bounding box is not detected based on the additional dimensioning data, the device 104 may identify an error condition and proceed to block 415 Accordingly, at block 415, the device 104 may present an error notification or similar to the user at the device 104. In other examples, the device 104 may additionally communicate an indication of the error to the server 116 or another computing device for further troubleshooting and operation management, or the like.

If, at block 410, a bounding box is successfully detected, the device 104 proceeds to block 420. At block 420, the device 104 determines the dimensions of the irregularly shaped target object based on the dimensions of the bounding box. That is, the device 104 may assign a height, width, and depth as defined by the bounding box.

In some examples, at block 425, the device 104 may annotate the additional dimensioning data to add to the annotated dataset in the repository 220. For example, the additional dimensioning data may be annotated with the non-cuboidal dimensioning function selected to dimension the target object and the resulting bounding box determined for the target object. As part of the annotated dataset, the results of the function selection may be used to further train the function selection model for better and more robust function selection during subsequent dimensioning operations.

In some examples, the additional dimensioning data resulting in an error condition may be omitted from the annotated dataset as a poor or negative result. In other examples, the additional dimensioning data resulting in an error condition may be annotated with the non-cuboidal dimensioning function selected and added to the annotated dataset to support training of the function selection model and reduce negative results.

After annotating the additional dimensioning data and adding the annotated data to the annotated dataset, the device 104 may then return to the method 300.

Returning to FIG. 3, at block 330, the device 104 may output the determined dimensions of the target object. For example, the device 104 may display the dimensions of the target object on a display of the device 104. In other examples, the device 104 may alternately or additionally send the dimensions of the target object to the server 116 for storage and further processing.

At block 335, the device 104 may annotate the preliminary dimensioning data to add to the annotated dataset in the repository 220. For example, the preliminary dimensioning data may be annotated with the shape classification determined for the target object. As part of the annotated dataset, the results of the shape classification of the target object may be used to further train the shape classification model for better and more robust shape classification during subsequent dimensioning operations.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for dimensioning a target object, the method comprising:
obtaining preliminary dimensioning data representing the target object;
determining, based on the preliminary dimensioning data, a shape classification for the target object;
when the shape classification for the target object is cuboidal, applying a cuboidal dimensioning function to the preliminary dimensioning data to obtain object dimensions;
when the shape classification for the target object is non-cuboidal:
selecting a non-cuboidal dimensioning function based on a preliminary bounding box of the target object detected in the preliminary dimensioning data;
applying the non-cuboidal dimensioning function to obtain the object dimensions.

2. The method of claim 1, wherein determining the shape classification comprises segmenting the preliminary dimensioning data and determining if the segmented preliminary dimensioning data includes a top plane.

3. The method of claim 1, wherein determining the shape classification comprises applying a shape classification model to the preliminary dimensioning data.

4. The method of claim 3, further comprising:
annotating the preliminary dimensioning data with the determined shape classification;
adding the annotated preliminary dimensioning data to an annotated dataset; and
updating the shape classification model based on the annotated dataset.

5. The method of claim 1, wherein the non-cuboidal dimensioning function is selected from: a two-point capture technique and a stream capture technique.

6. The method of claim 1, further comprising obtaining additional dimensioning data representing the target object prior to applying the selected non-cuboidal dimensioning function.

7. The method of claim 6, further comprising prompting a user to execute an additional interaction sequence corresponding to the selected non-cuboidal dimensioning function to obtain the additional dimensioning data.

8. The method of claim 6, wherein applying the non-cuboidal dimensioning function comprises detecting an additional bounding box for the target object from the additional dimensioning data.

9. The method of claim 8, further comprising, when no additional bounding box is detected, identifying an error condition.

10. The method of claim 1, wherein selecting the non-cuboidal dimensioning function comprises applying a function selection model to the preliminary dimensioning data.

11. A dimensioning device comprising:
a memory storing a cuboidal dimensioning function and one or more non-cuboidal dimensioning functions;
a processor interconnected with the memory, the processor configured to:
obtain preliminary dimensioning data representing a target object to be dimensioned;
determine, based on the preliminary dimensioning data, a shape classification for the target object;
when the shape classification for the target object is cuboidal, apply the cuboidal dimensioning function to the preliminary dimensioning data to obtain object dimensions;
when the shape classification for the target object is non-cuboidal:
select a non-cuboidal dimensioning function based on a preliminary bounding box of the target object detected in the preliminary dimensioning data;
apply the selected non-cuboidal dimensioning function to obtain the object dimensions.

12. The dimensioning device of claim 11, wherein to determine the shape classification, the processor is configured to: segment the preliminary dimensioning data and determine if the segmented preliminary dimensioning data includes a top plane.

13. The dimensioning device of claim 11, wherein to determine the shape classification, the processor is configured to: applying a shape classification model to the preliminary dimensioning data.

14. The dimensioning device of claim 13, wherein the processor is further configured to:
annotate the preliminary dimensioning data with the determined shape classification;
add the annotated preliminary dimensioning data to an annotated dataset; and
update the shape classification model based on the annotated dataset.

15. The dimensioning device of claim 11, wherein the non-cuboidal dimensioning function is selected from: a two-point capture technique and a stream capture technique.

16. The dimensioning device of claim 11, wherein the processor is further configured to obtain additional dimensioning data representing the target object prior to applying the selected non-cuboidal dimensioning function.

17. The dimensioning device of claim 16, wherein the processor is further configured to prompt a user to execute an additional interaction sequence corresponding to the selected non-cuboidal dimensioning function to obtain the additional dimensioning data.

18. The dimensioning device of claim 16, wherein, to apply the non-cuboidal dimensioning function the processor is configured to detect an additional bounding box for the target object from the additional dimensioning data.

19. The dimensioning device of claim 18, wherein the processor is further configured to, when no additional bounding box is detected, identify an error condition.

20. The dimensioning device of claim 11, wherein to select the non-cuboidal dimensioning function, the processor is configured to apply a function selection model to the preliminary dimensioning data.

21. A method for dimensioning a target object, the method comprising:
obtaining preliminary dimensioning data representing the target object;
segmenting the preliminary dimensioning data;
detecting, in the segmented preliminary dimensioning data, a top plane of the target object to identify the target object as cuboidal;
in response to detecting the top plane, applying a cuboidal dimensioning function to the preliminary dimensioning data to obtain object dimensions.

22. The method of claim 21, further comprising: applying a shape classification model to the preliminary dimensioning data to verify that the target object is cuboidal.

23. The method of claim 21, further comprising: when the top plane is not detected, selecting a non-cuboidal dimensioning function based on a preliminary bounding box of the target object detected in the preliminary dimensioning data and applying the non-cuboidal dimensioning function to obtain the object dimensions.
